(19) United States
(12) Patent Application Publication
(10) Pub. No.: US 2012/0189383 A1
(43) Pub. Date: Jul. 26, 2012

(54) LATCH SYSTEM FOR COUPLING PRECISION FRAMES

(76) Inventors: Scot C. Fairchild, Santa Clara, CA (US); David Inori, Santa Rosa, CA (US); Jeffrey S. Thayer, Montara, CA (US); Nigel F. Misso, San Jose, CA (US)

(21) Appl. No.: 13/013,759

(22) Filed: Jan. 25, 2011

(51) Int. Cl. F16B 5/00

(52) U.S. Cl. 403/376

(57) ABSTRACT

A latch system couples precision frames in a way that does not over-constrain the coupled frames. The position of a female latching device mounted to one precision frame is adjustable so that, prior to coupling, the latching device can be aligned to a fixed pin that is part of a fixed pin assembly mounted to a second precision frame. Once positioned, the female latching device is fixed in position with respect to the pin and mechanically coupled to the pin, so that the first and second precision frames are not distorted when the coupling takes place. Such latch systems can be used to provide a rigid and over-constrained connection between two structures that does not contain interference fits or the resultant deflection associated with interference fits.

### BACKGROUND OF THE INVENTION

1. Field of the Invention

Embodiments of the present invention relate generally to latching devices and, more specifically, to a latch system for coupling precision frames.

2. Description of the Related Art

Electronic display systems are commonly used to display information from computers and other sources. Typical display systems range in size from small displays used in mobile devices to very large displays that are used to display images to thousands of viewers at one time. Tiled display walls provide a large-format environment for presenting large high-resolution images by synchronizing and coupling the output from multiple distinct imaging systems. Such large displays may be created by tiling a plurality of smaller display devices together. For example, the video walls frequently seen in the electronic media typically use multiple display modules, such as flat-panel displays, which are tiled to create such large displays.

One issue with tiled displays is that the gap present between constituent display modules can produce a grid pattern distracting to a viewer. Such a grid pattern can be more noticeable to the viewer depending on the way in which the smaller display devices are assembled to form the tiled display. Typically, the frames on which individual tiles are mounted and bolted together to form tiled displays are fastened together using indexing features and clamping mechanisms. The indexing features position the frames relative to each other and the clamping mechanisms mechanically couple the frames into a single rigid structure. Because the indexing features have tolerances loose enough to ensure that the frames can be positioned and assembled without mechanical interference between the individual frames, once the clamps are actuated and pull against the adjacent frames and indexing features, some or all of the frames are typically deflected. In other words, the tolerance stacking between frames causes such an arrangement of frames to be over-constrained so that the final position of each display tile is not determined by the original shape of the frame. The resultant gaps between display tiles can be large and irregular, leading to a more noticeable and more distracting grid pattern in a tiled display.

As the foregoing illustrates, there is a need in the art for a system for mechanically coupling precision frames into a rigid structural array in a way that does not disturb datum features of the precision frames.

### SUMMARY OF THE INVENTION

One embodiment of the present invention sets forth a latch system for coupling precision frames in a way that does not over-constrain the coupled frames so that the frames are not distorted from their precisely defined shape after being mechanically coupled to each other. The position of a female latching device mounted to one precision frame is adjustable in one or two directions so that, prior to coupling, the latching device can be aligned to a fixed pin that is part of a fixed pin assembly mounted to a second precision frame. Once positioned, the female latching device is fixed in position with respect to the pin and mechanically coupled to the pin, so that the first and second precision frames are not distorted when the coupling takes place. Such latch systems can be used to provide a rigid and over-constrained connection between two structures that does not contain interference fits.

One advantage of the present invention is that two or more precision frames can be coupled to each other in a structurally sound fashion while maintaining the integrity of datum features disposed on the frames.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 schematically illustrates a latch system configured to mechanically couple together precision frames to form a rigid structural truss, according to various embodiments of the invention;

FIG. 2 illustrates a cross-sectional side view of a fixed pin assembly that forms a male portion of the latch system of FIG. 1, according to one embodiment of the invention;

FIG. 3 illustrates a fixed pin assembly that includes a hinge and forms a male portion of the latch system of FIG. 1, according to another embodiment of the invention;

FIG. 4A illustrates a cross-sectional side view of a female latching device, according to one embodiment of the invention;

FIG. 4B illustrates a perspective view of the female latching device of FIG. 4A, where elements configured to produce a locking force on a fixed pin included in a fixed pin assembly have been removed for clarity;

FIG. 5 illustrates how two precision frames that include two of the latching systems of FIG. 1 may be coupled together, according to one embodiment of the invention;

FIG. 6 illustrates a perspective view of a female latching device that forms a female portion of the latch system of FIG. 1, according to a different embodiment of the invention;

FIG. 7 illustrates an exploded perspective view of the female latching device of FIG. 6;

FIG. 8 illustrates a cross-sectional side view of the female latching device of FIG. 6 and a hollow fixed pin assembly that forms a male portion of the latch system of FIG. 1, according to the different embodiment of the invention; and

FIG. 9 illustrates a bulkhead of a precision frame configured with three latch systems, according to various embodiments of the invention.

For clarity, identical reference numbers have been used, where applicable, to designate identical elements that are common between figures. It is contemplated that features of one embodiment may be incorporated in other embodiments without further recitation.

### DETAILED DESCRIPTION

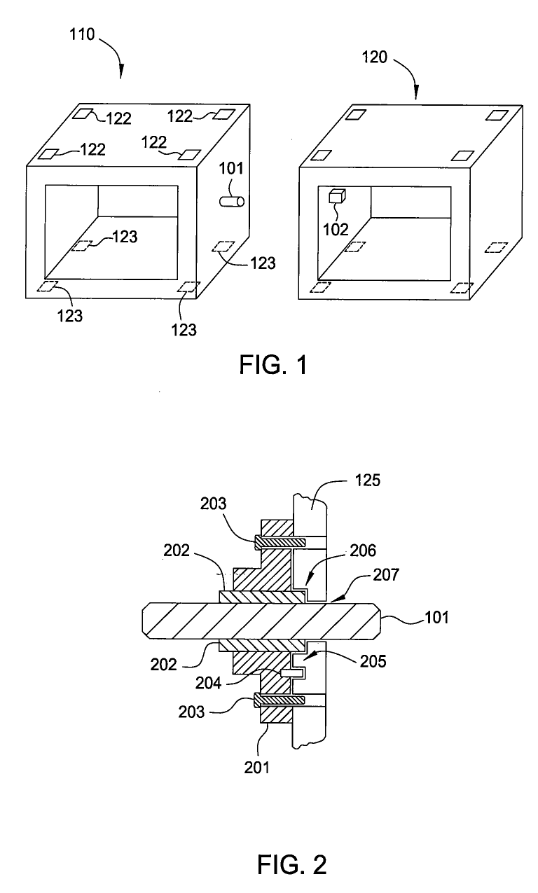

FIG. 1 schematically illustrates a latch system 100 configured to mechanically couple precision frames to form a rigid structural truss, according to embodiments of the invention. A precision frame, as defined herein, is a structure having precisely located datum surfaces, projections, and/or other features configured to define the position of the structure when mechanically coupled to another such structure. Latch system 100 includes a fixed pin 101 that is part of a fixed pin assembly 150 and a female latching device 102. As shown, fixed pin assembly 150 is mounted to a first precision frame 110 and female latching device 102 is mounted to a second precision frame 120. First precision frame 110 and second precision frame 120 are mechanically coupled to each other to form a single rigid structure with precisely defined datum structures when female latching device 102 locks on to fixed pin 101. For clarity, in FIG. 1 first precision frame 110 and second precision frame 120 are not depicted being mechanically coupled by latch system 100, so female latching device 102 is not shown locked onto fixed pin 101 and first precision frame 110 and second precision frame 120 are not shown in contact with each other.

First precision frame 110 may be a structural assembly having precise datum structures that, when positioned in contact with corresponding datum structures on second precision frame 120, define the position of first precision frame 110 with respect to second precision frame 120 within a tight tolerance level. Second precision frame 120 is similarly constructed so that, when mechanically coupled by latch system 100, a structural truss is formed having precisely defined dimensions. More of such frames may be coupled to first precision frame 110 and second precision frame 120 to expand the size and shape of the structural truss. Features of first precision frame 110 and second precision frame 120 that may be suitable datum structures include precisely dimensioned flat surfaces, such as surface 121 on a side bulkhead 125, top pads 122, and bottom pads 123, and precisely placed pins, such as fixed pin 101.

According to embodiments of the invention, female latching device 102 includes a position-adjustment mechanism so that the position of female latching device 102 can be adjusted to accommodate the exact position of fixed pin 101 before female latching device 102 is coupled to fixed pin 101. Once aligned with fixed pin 101, female latching device 102 is fixed in position and mechanically coupled to fixed pin 101, so that the first and second precision frames are not distorted when the coupling takes place. Consequently, no pre-load is applied to the frames when being coupled together, and no significant deflection of the frames therefore takes place. This is even true when multiple frames are mechanically coupled in a 2-dimensional array and the propagation of tolerance-stacking effects produces significant displacement between the predicted location of fixed pin 101 and the actual location thereof. With no significant pre-load applied to first precision frame 110 and second precision frame 120 when mechanically coupled by latch system 100, first precision frame 110 and second precision frame 120 are not distorted from their precisely defined shapes.

In one embodiment, an array of multiple precision frames so formed is used to create a tiled display wall, where each precision frame rigidly and precisely holds a single display tile in position relative to the adjacent display tiles making up the tiled display wall. Because the frames are not distorted from their original and precisely defined shapes after being assembled into the array, the edges of display modules mounted in the precision frames are accurately aligned, resulting in smaller and more uniform gaps therebetween. Narrow and consistently sized gaps are much less noticeable to a viewer of the tiled display wall.

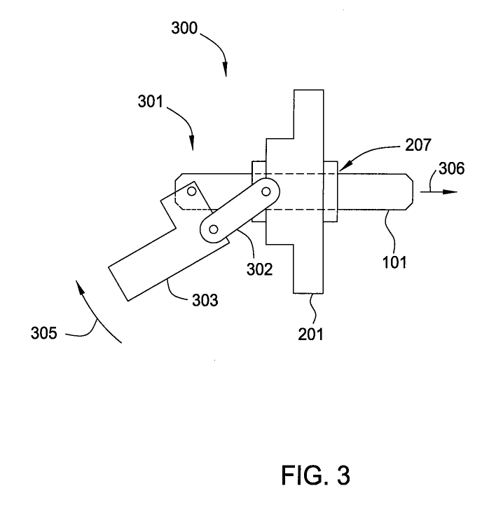

Fixed pin 101 is a datum structure of first precision frame 110 that is also a component of latch system 100. Fixed pin 101 is positioned on surface 121 of side bulkhead 125 to a tight tolerance with respect to other datum features, such as top pads 122, and bottom pads 123. In one embodiment, fixed pin 101 is part of a fixed pin assembly and is coupled to a mounting plate via a precise locating bushing to facilitate the exact placement of fixed pin 101 on side bulkhead 125 while allowing fixed pin 101 to be deployed or retracted, thereby facilitating assembly and disassembly of multiple adjacent frames. FIG. 2 illustrates a cross-sectional side view of a fixed pin assembly 150 that forms a male portion of the latch system of FIG. 1, according to one embodiment of the invention. Fixed pin assembly fixed 150 is mounted to side bulkhead 125 of first precision frame 110, and is configured with fixed pin 101, a mounting plate 201, and a locating bushing 202. Mounting plate 201 is coupled to side bulkhead 125 with threaded fasteners 203 or other similar fasteners. Mounting plate 201 allows precise positioning of fixed pin 101 in side bulkhead 125 and locating bushing 202 allows fixed pin 101 to be inserted through and removed from side bulkhead 125.

The location at which fixed pin 101 penetrates side bulkhead 125 may be determined using various mechanisms. In one embodiment, fixed pin 101 is positioned in mounting plate 201 via locating bushing 202, and one or more precision pins 204 fixed in mounting plate 201 are aligned with a precisely located hole 205 in bulkhead 125. In another embodiment, the positions of threaded fasteners 203 are precisely located in bulkhead 125 in order to precisely locate mounting plate 201 and, consequently, fixed pin 101. In yet another embodiment, a precisely positioned bevel 206 formed in bulkhead 125 mates with locating bushing 202 to determine the location of fixed pin 101. In still another embodiment, an opening 207 in side bulkhead 125 is a precision opening that determines the location of fixed pin 101.

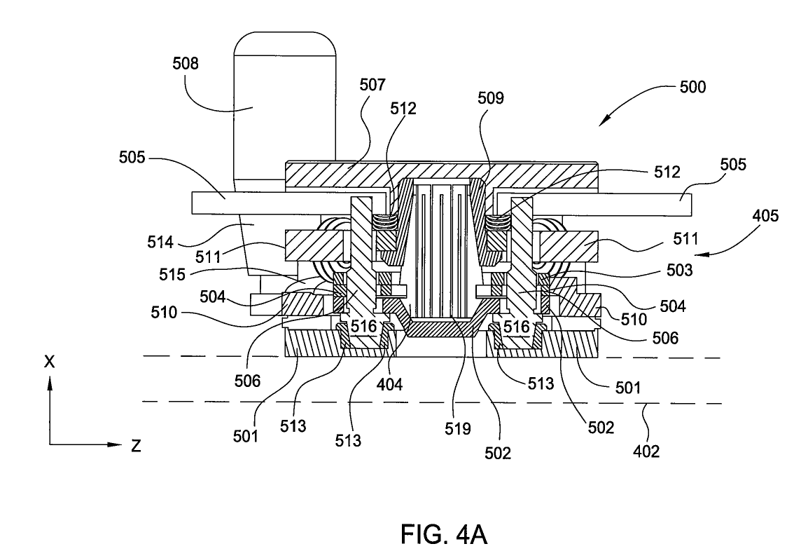

In some embodiments, fixed pin 101 may be further configured with a hinged assembly to facilitate retracting and deploying pin 101. FIG. 3 illustrates a fixed pin assembly 300 that includes a hinge and forms a male portion of the latch system of FIG. 1, according to another embodiment of the invention. As shown, a hinged assembly 301 includes a linkage element 302 and a handle 303. Linkage element 302 is rotatably coupled to mounting plate 201, handle 303 is rotatably coupled to fixed pin 101, and linkage element 302 and handle 303 are rotatably coupled to each other. As shown, actuation of handle 303 in the direction of arrow 305 deploys fixed pin 101 in direction 306 and through opening 207 of side bulkhead 125.

Embodiments of the invention contemplate various configurations of female latching device 102. In some embodiments female latching device 102 is adjustable in one direction with respect to fixed pin 101, and in some embodiments female latching device 102 is adjustable in two directions with respect to fixed pin 101. In a preferred embodiment, these two directions of adjustment are orthogonal to each other. In some embodiments, female latching device 102 uses a collet to couple to fixed pin 101. Compression springs in female latching device 102 are configured to simultaneously compress the collet onto fixed pin 101 and fix the position of female latching device 102 with respect to the pin. In other embodiments, fixed pin assembly 150 includes a hollow pin and female latching device 102 uses a bolt disposed in fixed pin 101 to simultaneously compress a position-adjustment mechanism and mechanically couple female latching device 102 to fixed pin 101. Different combinations of these configurations are contemplated by embodiments of the invention.

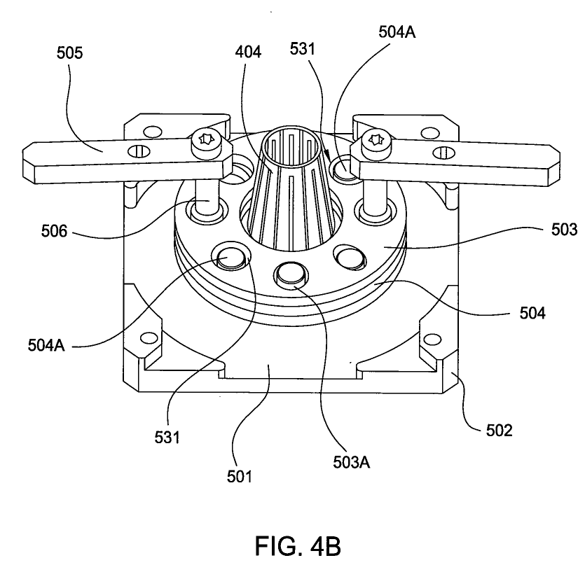

FIG. 4A illustrates a cross-sectional side view of a female latching device 400, according to one embodiment of the invention. For purposes of description, axis x is considered the horizontal with respect to a precision frame on which female latching device 400 is mounted, such as precision frame 110. Axis y (out of page) is considered the vertical with respect to the precision frame, and axis z is considered the depth or front-to-back dimension of the precision frame. For reference, a bulkhead 402, on which female latching device 400 is mounted, is also depicted. Female latching device 400 includes a housing assembly 500 and several actuators that extent outside of housing assembly 500: a release handle 508, which is coupled to a release plate 510, and eccentric levers 505, which are coupled to eccentric rotating elements 506. Housing assembly 500 includes a base plate 501, release plate 510, a clutch plate 511 and a top plate 507, which are bolted together into a single assembly. A collet 404 and the components of a position-adjustment mechanism 405 are disposed in housing assembly 500. Position-adjustment mechanism 405 is configured to adjust the position of collet 404 in the y- and z-directions, where axis y points into the page in FIG. 4A. Components of position-adjustment mechanism 405 include eccentric levers 505, eccentric rotating elements 506, slider plates 503 and 504, and tapered bushings 513. Operation of position-adjustment mechanism 405 is described below in conjunction with FIG. 4B. Other components of female latching device 400 are configured to lock collet 404 onto and release collet 404 from fixed pin 101 (not shown for clarity), and include a tapered element 509 contacting the angled surface of collet 404, a plurality of compression springs 512 disposed between clutch plate 511 and top plate 507, a plurality of rollers 514 pinned to clutch plate 511, a seat plate 502 pressed against a bottom surface of collet 404, and rotatable release plate 510, which is configured with ramped surfaces 515 in contact with rollers 514.

In operation, female latching device 400 either locks collet 404 onto fixed pin 101 or releases collet from fixed pin 101. The locking force is generated using compression springs 512, which produce a force directed along axis x, i.e., a vertical force, when clutch plate 511 is lowered. When lowered, clutch plate 511 contacts and pushes tapered element 509 downward, and tapered element 509 squeezes collet 404 around fixed pin 101. This squeeze produces the strong joint between female latching device 400 and fixed pin 101.

The vertical force pressing downward on tapered element 509 is released when clutch plate 511 is raised. This vertical force is released when release plate 510 is rotated by release handle 508 and ramps 515 on release plate 510 apply upward force to rollers 514. Because rollers 514 are pinned to clutch plate 511, clutch plate 511 is raised in the positive x-direction and tapered element 509 stops squeezing collet 404. Thus, clutch plate 511 can be lifted or lowered and the locking force on fixed pin released or applied using release handle 508. When the clutch plate is lowered and the locking force is applied to fixed pin 101, a bottom end 519 of collet 404 is also compressed by seat plate 502. Thus, when collet 404 tightens around fixed pin 101, the vertical force is transferred from seat plate 502 to the two eccentric rotating elements 506. Eccentric rotating elements 506 each have a tapered end 516 that rests in a tapered bushing 513. The vertical force presses tapered end 516 of each eccentric rotating element 506 into tapered bushing 513 and prevents rotational motion of eccentric rotating elements 506. Because such rotation adjusts the position of collet 404 with respect to a fixed pin 101, the vertical force that presses downward on tapered element 509 and produces the locking force with fixed pin 101 also fixes the position of collet 404 with respect to fixed pin 101.

Adjustment of collet 404 so that it is in alignment with a fixed pin 101 is now described. Collet 404 and seat plate 502 are configured to move together in the y- and z-directions, and eccentric rotating elements 506 are configured to move seat plate 502 via slider plates 503, 504 when rotated by eccentric levers 505. Because eccentric rotating elements 506 each include an eccentrically placed rotating shaft, eccentric rotating elements 506 impart horizontal motion to slider plates 503, 504 when rotated. Thus, by actuating eccentric levers 505, the position of collet 404 in the y- and z-directions can be adjusted to be in alignment with a fixed pin 101. FIG. 4B illustrates a perspective view of the female latching device of FIG. 4A, where elements configured to produce a locking force on a fixed pin included in a fixed pin assembly have been removed for clarity. Components of female latching device 400 that have been removed in FIG. 4B include top plate 507, tapered element 509, clutch plate 511, compression springs 512 and release plate 510. Slider plates 503 and 504 each have pins engaged to seat plate 502 so that each of slider plates 503 and 504 can move seat plate 502 independently. In FIG. 4B, one such connecting pin 503A for slider plate 503 is visible, and passes through a clearance hole (hidden) in slider plate 504. The connecting pins 504A for slider plate 504 are visible inside clearance holes 531, which are formed in slider plate 503. Slider plates 503 and 504 are configured with slots and other clearance holes so that rotation of one eccentric rotating element 506 engages slider plate 503 and moves seat plate 502 in one direction and rotation of the other eccentric rotating element 506 engages slider plate 504 and moves seat plate 502 in another direction. In one embodiment, the two directions are orthogonal.

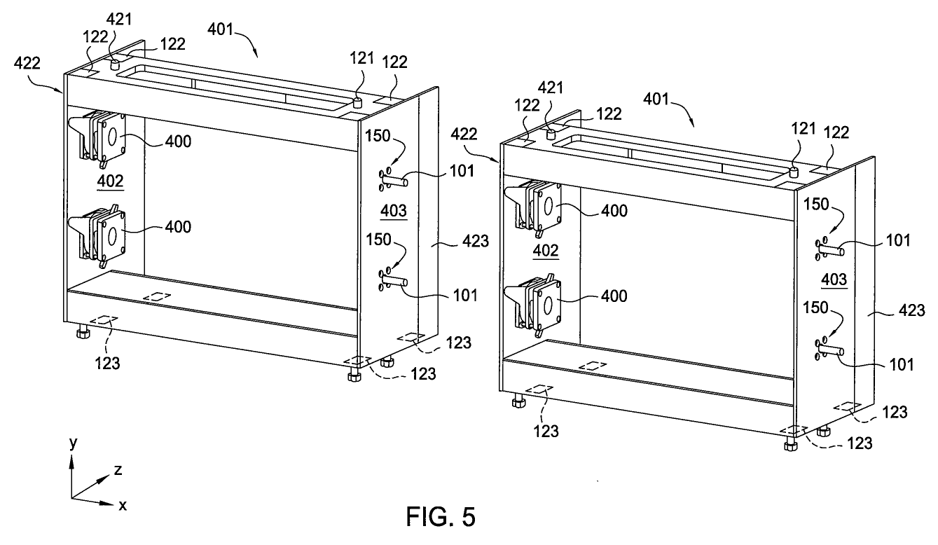

FIG. 5 illustrates how two precision frames that include two of the latching systems of FIG. 1 may be coupled together, according to one embodiment of the invention. Two precision frames 401 are shown, each configured with two female latching devices 400 mounted on bulkhead 402 and two fixed pin assemblies 150 mounted on an opposing bulkhead 403, according to embodiments of the invention. For purposes of description, axis x is considered the horizontal, axis y is considered the vertical, and axis z is considered the depth or front-to-back dimension of precision frames 401. Female latch devices 400 are configured to mechanically couple to corresponding fixed pins 101 from the adjacent precision frame. In the embodiment depicted in FIG. 4, each female latching device 400 includes collet 404 (shown in FIGS. 4A, 4B) configured to lock onto a corresponding fixed pin 101 of an adjacent precision frame 401. Female latching devices 400 also include a position-adjustment mechanism 405 (shown in FIGS. 4A, 4B) configured to adjust the position of collet 404 to be in alignment with the appropriate fixed pin 101 prior to locking collet 404 onto the fixed pin 101. Because the position of female latching devices 400 can be adjusted to accommodate the actual position of each fixed pin 101, no pre-load is applied to each fixed pin in the y- and z-directions and other datum features of precision frame 401 do not bind against corresponding datum features of adjacent precision frames 401.

Female latching devices 400, together with fixed pins 101, provide a latching mechanism for precisely and robustly coupling precision frame 401 to adjacent precision frames. Specifically, fixed pins 101 are very rigid in the y- and z-directions, and therefore provide precise positioning of adjacent precision frames with respect to axis y and axis z. Left surface 422 of bulkhead 402 and right surface 423 of bulkhead 403 provide precise positioning of adjacent precision frames with respect to axis x. In addition, top pads 122 may contact bottom pads 123 of vertically adjacent frames to further provide precise position with respect to axis y. In some embodiments, more than two sets latching mechanisms may be employed to provide further stability in a large array of precision frames 401. For example, a third latching mechanism may be located at a different z-direction coordinate than the two female latching devices 400 and fixed pins 101 illustrated in FIG. 4. Since these two latching mechanisms are aligned vertically, i.e., they are positioned at the same z-coordinate, the addition of a third latching mechanism located at a different z-coordinate will provide substantially greater stability in an array of precision frames 401 by preventing rotation about axis y of each precision frame 401 with respect to neighboring precision frames 401.

In the embodiment illustrated in FIG. 4, female latching devices 400 and fixed pins 101 are used to mechanically couple adjacent precision frames 401 horizontally, and a different alignment scheme is used to couple adjacent precision frames 401 vertically. Specifically, precision pins 421 disposed on the top of each precision frame 401 mate with tight tolerance slots (not shown) disposed on the bottom of each frame. In other embodiments, an alignment and coupling scheme substantially similar to female latching devices 400 and fixed pins 101 may also be implemented for vertical alignment and mechanical coupling of precision frames.

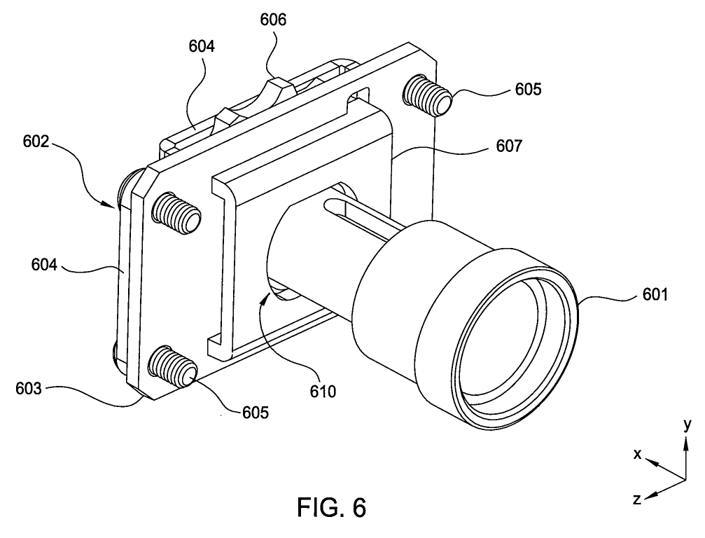

FIG. 6 illustrates a perspective view of a female latching device 602 that forms a female portion of the latch system of FIG. 1, according to a different embodiment of the invention. A latch system 600 includes a hollow fixed pin assembly 650 with a hollow fixed pin 601 and a female latching device 602 that uses a bolt to lock onto hollow fixed pin 601, according to embodiments of the invention. For clarity, only hollow fixed pin 601 of hollow fixed pin assembly 650 is shown, and the bulkheads on which female latching device 602 and hollow fixed pin assembly 650 are mounted are omitted. Female latching device 602 includes a mounting plate 603 and a clamping plate w, which are both fixedly mounted to a bulkhead of a precision frame, such as second precision frame 120 in FIG. 1. In some embodiments, screws 605 are used to attach both mounting plate 603 and clamping plate 604 to the bulkhead of precision frame 120. Female latching device 602 further includes an eccentric rotating element 606 disposed between mounting plate 603 and clamping plate 604 and a follower plate 607 disposed between mounting plate 603 and the bulkhead on which female latching device 602 is mounted, e.g., precision frame 120.

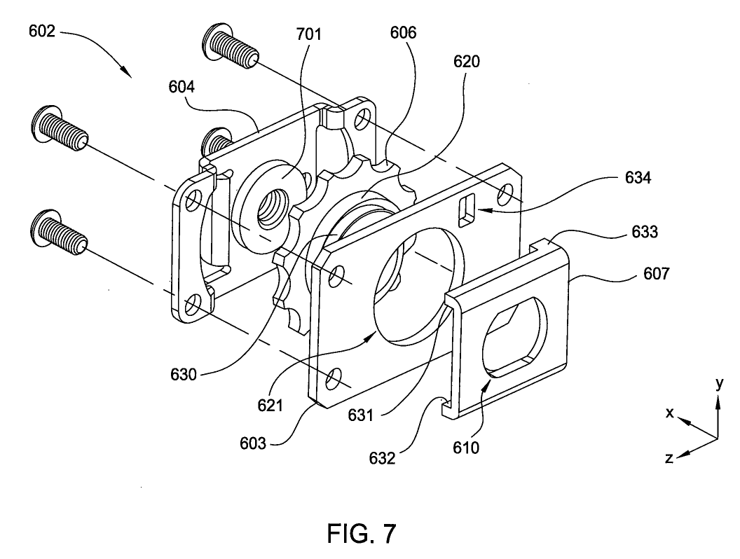

Follower plate 607 is slotted in one direction with slotted opening 610, to allow movement of hollow pin 601 in the z direction. In addition, slotted opening 610 of follower plate 607 is configured to precisely fit within a tight tolerance an outer dimension of hollow fixed pin 601, e.g., the outer diameter, in an orthogonal direction, thereby producing a precision fit with the outer diameter of hollow fixed pin 601. In some embodiments, the tight tolerance between slotted opening 610 and the outer diameter of hollow fixed pin 601 is a “running and sliding fit” as defined by Machinery's Handbook, such as a close sliding fit, a sliding fit, or a precision running fit. In the embodiment illustrated in FIG. 6, follower plate 607 is slotted in the z-direction and has a precision fit with hollow fixed pin 601 in the y-direction. Consequently, when hollow fixed pin 601 is mated with female latching device 602 and is inserted in a slotted opening 610 of follower plate 607, any displacement between hollow fixed pin 601 and female latching device 602 in the z-direction due to tolerance stacking, etc., is readily accommodated by slotted opening 610 in follower plate 607. However, any displacement between female latching device 602 and hollow fixed pin 601 in the y-direction can only be accommodated by adjusting the position of female latching device 602 using eccentric rotating element 606, which is shown in greater detail in FIG. 7. Thus, the position of female latching device 602 can be readily adjusted to accommodate the position of hollow fixed pin 601 prior to locking female latching device 602 onto hollow fixed pin 601.

FIG. 7 illustrates an exploded perspective view of the female latching device of FIG. 6. As shown, eccentric rotating element 606 includes a centered cylindrical surface 620 and an eccentric cylindrical surface 630. Centered cylindrical surface 620 mates with and rotates inside circular opening 621 of mounting plate 603 when eccentric rotating element 606 is rotated to adjust the position of female latching device 602 in the y-direction. Eccentric cylindrical surface 630 is offset from the center of rotation of centered cylindrical surface 620, and contacts horizontal surfaces 631, 632 of follower plate 607. The position of follower plate 607 changes in the y-direction when eccentric rotating element 606 rotates because horizontal surfaces 631, 632 ride on eccentric cylindrical surface 630 and follower plate motion is constrained in the y-direction by pin 633 and slot 634.

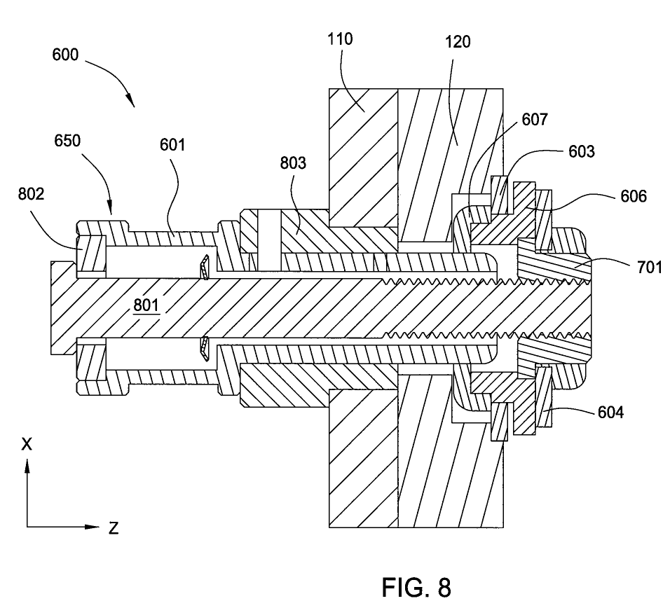

A fastener 701 is attached as shown to clamping plate 604 and is configured to couple to a bolt 801 (shown in FIG. 8). Fastener 701 may be a threaded fastener or other fastener configured to couple with bolt 801. When fastener 701 is coupled with bolt 801, a clamping force is produced to lock female latching device 602 onto hollow fixed pin 601. Fastener 701 is coupled to bolt 801 after female latching device 602 is adjusted to the position of hollow fixed pin 601. Thus, female latching device 602 can be precisely aligned with hollow fixed pin 601 prior to mechanically coupling hollow fixed pin 601 and female latching device 602. In this way, female latching device 602 is mechanically coupled to hollow fixed pin 601 in a structurally robust fashion without imparting a significant preload onto hollow fixed pin 601, thereby preventing deflection of first precision frame 110 and second precision frame 120.

FIG. 8 illustrates a cross-sectional side view of the female latching device of FIG. 6 and hollow fixed pin assembly 650 that forms a male portion of the latch system of FIG. 1, according to the different embodiment of the invention. Hollow fixed pin assembly 650 may include a washer 802 to keep a standard bolt captive to pin assembly 650. Hollow fixed pin assembly 650 may further include a precision bushing 803 to precisely locate hollow fixed pin 601 in a bulkhead of first precision frame 110. As shown, bolt 801 is disposed inside hollow fixed pin 601, passes through follower plate 607, mounting plate 603, and eccentric rotating element 606, and is coupled to fastener 701. When bolt 801 is tightened in fastener 701, a high clamping force is produced that compresses eccentric rotating element 606 against mounting plate 603 preventing rotation of eccentric rotating element 606. With eccentric rotating element 606 unable to rotate, the motion of female latching device 602 relative to hollow fixed pin 601 in the y-direction is prevented. This is due to the precision fit between slotted opening 610 in follower plate 607 and the outer diameter of hollow fixed pin 601 in the y-direction. It is noted that, in addition to a high clamping force that immobilizes female latching device 602 with respect to hollow fixed pin 601, bolt 801 also provides a high-strength connection therebetween, including a high pull-out strength, i.e., on the order of thousands of pounds. In addition, latch system 600 facilitates assembly of precision frames since follower plate 607 only has a precise fit in one direction with hollow fixed pin 601 and also because hollow fixed pin may be configured to be retractable.

In some embodiments of the invention, multiple latch systems 600 may be employed to couple two precision frames. Because a single latch system 600 tightly constrains the relative motion between coupled frames in one of the y- or z-directions, the use of multiple latch systems 600 to couple two precision frames can provide a more stable connection. This is because each latch system 600 can be adjusted, while remaining structurally sound, to serve as an additional datum feature between two precision frames that may already have a precisely defined positional relationship created by other datum features and surfaces. Therefore, the rigidity of an over-constrained relationship between the precision frames can be realized without the deflection associated with a typical over-constrained connection between two structures that contains interference fits and their resultant deflection.

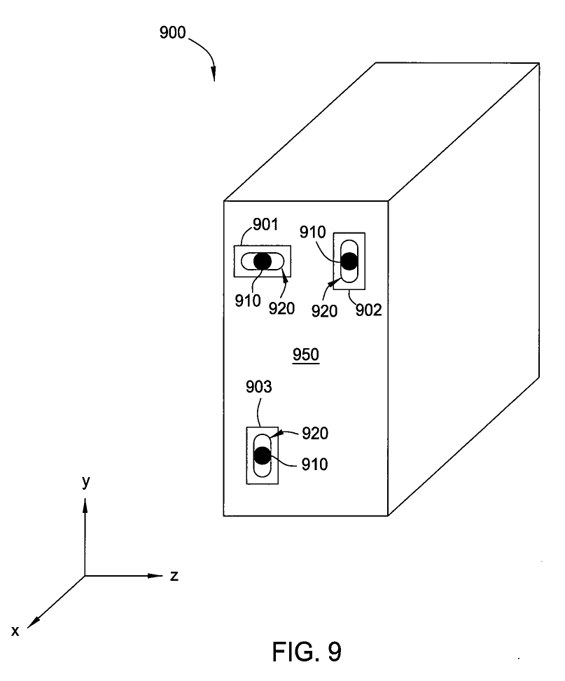

FIG. 9 illustrates a bulkhead 900 of a precision frame 900 configured with three latch systems 901, 902, and 903, according to embodiments of the invention. Disposed on bulkhead 950 are three latch systems 901, 902, and 903, which are substantially similar in organization to latch system 600 in FIG. 6. For clarity, only the fixed pins 910 and follower plate slotted openings 920 of latch systems 901, 902, and 903 are shown. Latch systems 902 and 903 prevent rotation of precision frame 900 about axis y when couple to an adjacent precision frame. Similarly, latch systems 901 and 903 prevent rotation of precision frame 900 about axis z and latch systems 901 and 903 prevent rotation of precision frame 900 about axis x. Other configurations of multiple latch systems are also contemplated by embodiments of the invention, including employing more than three latch systems on a single bulkhead surface and locating and/or orienting the latch systems being employed in a different fashion than illustrated in FIG. 9.

As detailed above, in some embodiments a collet is used to lock a female latching device onto a pin, and in other embodiments a bolt is used to compress a pin against a female latching device. The use of other schemes for applying a locking force between a fixed pin and a female latching device that has an adjustable position also falls within the scope of the invention. For example, set screws, clamping devices, or other apparatus may be used to exert a locking force between a fixed pin mounted on one precision frame and a female latching device having an adjustable position and mounted on a second precision frame. Further, other position-adjustment mechanisms may be used to adjust a female latching device in order to accommodate an offset with a precision-placed fixed pin. For example, screw-based devices, levers, and other mechanisms fall within the scope of the present invention when employed to adjust the position of a female latching mechanism to be aligned with a fixed pin.

In sum, embodiments of the invention provide latch systems for mechanically coupling precision frames. By accommodating small variations in the actual location of precisely fixed pins disposed on each frame, latching devices can be mechanically coupled to the fixed pins without imparting significant preload or distorting the precision frames. Thus, according to embodiments of the invention, precision frames can be advantageously assembled into a rigid structural truss, such as an extensive two-dimensional array, in a way that maintains the precise dimensioning of the frames. When such a structural truss is used for a tiled wall display, small and consistent gaps between each display tile can be maintained, thereby advantageously enhancing the appearance of a displayed image.

While the foregoing is directed to embodiments of the present invention, other and further embodiments of the invention may be devised without departing from the basic scope thereof, and the scope thereof is determined by the claims that follow.

We claim:

1. A latch system for coupling precision frames, comprising:
a female latching device mounted to one side of a first precision frame and including:
a follower plate configured with a slotted opening to accommodate a pin that is part of a fixed pin assembly mounted to one side of a second precision frame,
a position-adjustment mechanism configured to adjust a position of the follower plate with respect to the pin along a first axis when the position-adjustment mechanism is rotated, and
a fastener configured to couple to a bolt disposed inside the pin,
wherein the bolt fixes the position of the position-adjustment mechanism when the fastener is coupled to the bolt.

2. The latch system of claim 1, wherein the female latching device is configured to accommodate a difference between a predicted position of the pin and an actual position of the pin when the fastener is coupled to the bolt.

3. The latch system of claim 1, wherein the position-adjustment mechanism includes an eccentric shaft with an eccentric cylindrical surface that is offset from the center of rotation of the eccentric shaft and configured to adjust the position of the follower plate with respect to the pin along a first axis when the eccentric shaft is rotated.

4. The latch system of claim 1, wherein the slotted opening is configured with a running and sliding fit to an outer dimension of the pin in the direction of the first axis.

5. The latch system of claim 1, wherein the follower plate is constrained from moving orthogonally with respect to the first axis when the position-adjustment mechanism is rotated.

6. The latch system of claim 1, wherein the follower plate is configured to adjust the position of the female latching device with respect to the pin before the fastener is coupled to the bolt.

7. The latch system of claim 1, wherein the fastener, when coupled to the bolt, produces a clamping force that compresses the position-adjustment mechanism.

8. The latch system of claim 7, wherein the position-adjustment mechanism further includes an eccentric rotating element, and the clamping force compresses the eccentric rotating element between the fastener and the one side of the first precision frame to prevent the position-adjustment mechanism from rotating.

9. The latch system of claim 1, wherein the fixed pin and bolt assembly are captive on the frame.

10. The latch system of claim 1, wherein the pin is mounted to the one side of the second precision frame with a locating bushing.

11. A latch system for coupling precision frames, comprising:
first and second female latching devices mounted to one side of a first precision frame, each of the first and second female latching devices comprising:
a follower plate configured with a slotted opening to accommodate a pin that is part of a fixed pin assembly mounted to one side of a second precision frame,
a position-adjustment mechanism configured to adjust a position of the follower plate with respect to the pin along an axis when the position-adjustment mechanism is rotated, and
a fastener configured to couple to a bolt disposed inside the pin,
wherein the bolt fixes the position of the position-adjustment mechanism when the fastener is coupled to the bolt.

12. The latch system of claim 11, wherein, when the bolt is coupled to the fastener, the first female latching device is configured to accommodate a difference between a predicted position of the first pin and an actual position of the first pin and the second female latching device is configured to accommodate a difference between a predicted position of the second pin and an actual position of the second pin.

13. The latch system of claim 11, further comprising a third pin that is part of a fixed pin assembly mounted to the one side of the second precision frame and a third female latching device mounted to the one side of the first precision frame.

14. The latch system of claim 13, wherein the first, second and third pins define an over-constrained relationship between the first precision frame and the second precision frame that is substantially free of interference fits.

15. The latch system of claim 11, wherein each of the first fixed pin assembly and the second fixed pin assembly is configured with a mechanism for retracting the fixed pin that is part of the fixed pin assembly.

16. The latch system of claim 11, wherein the position-adjustment mechanism of the first female latching device is configured to adjust a position of the follower plate with respect to the pin along a first axis, the position-adjustment mechanism of the second female latching device is configured to adjust a position of the follower plate with respect to the pin along a second axis, and the first axis is substantially orthogonal to the second axis.

17. The latch system of claim 11, wherein the position-adjustment mechanism includes an eccentric cylindrical surface that is offset from the center of rotation of the position-adjustment mechanism and configured to adjust the position of the follower plate with respect to the pin along a first axis when the position-adjustment mechanism is rotated.

18. The latch system of claim 11, wherein the slotted opening is configured to precisely fit an outer dimension of the pin in the direction of the first axis.

19. The latch system of claim 11, wherein the follower plate is constrained from moving orthogonally with respect to the first axis when the position-adjustment mechanism is rotated.

20. The latch system of claim 11, wherein the follower plate is configured to adjust the position of the female latching device with respect to the pin before the fastener is coupled to the bolt.
